(19) United States
(12) Patent Application Publication
(10) Pub. No.: US 2025/0139475 A1
(43) Pub. Date: May 1, 2025

(54) METHOD AND SYSTEM FOR FEDERATED LEARNING

(71) Applicant: STANDARD CHARTERED BANK, SINGAPORE BRANCH, Singapore (SG)

(72) Inventors: Jun XU, Singapore (SG); Hengjie SONG, Guangzhou (CN); Yueyue SHI, Guangzhou (CN)

(73) Assignee: STANDARD CHARTERED BANK, SINGAPORE BRANCH, Singapore (SG)

(21) Appl. No.: 18/930,421

(22) Filed: Oct. 29, 2024

(30) Foreign Application Priority Data
Oct. 30, 2023 (SG) 10202303060U

(51) Int. Cl. G06N 7/01

(52) U.S. Cl. CPC G06N 7/01

(57) ABSTRACT

In a described embodiment, a first model for processing a first set of data corresponding to a first data space, in which the first model includes a first feature extractor configured to extract a first set of feature representations is implemented. A second model is implemented for processing a second set of data corresponding to a second data space, in which the second model includes a second feature extractor configured to extract a second set of feature representations. Information from the second model to the first model is transferred via a connection, in which the connection links the first model and the second model. The second model is trained using a labeled set derived from the second set of data and the first model is trained using a labeled set derived from the first set of data and a plurality of outputs from the second feature extractor. Parameters of the second model are aggregated to form a global model.

### CROSS REFERENCE TO RELATED APPLICATIONS

The present application claims priority from Singapore Patent Application No. 10202303060U filed on Oct. 30, 2023, and entitled “METHOD AND SYSTEM FOR FEDERATED LEARNING”, the disclosure of which is incorporated herein by reference.

### TECHNICAL FIELD

The present application pertains generally to methods and systems for machine learning in a distributed computing environment, and in particular leveraging various datasets to pre-train machine learning models in a privacy-preserving manner for implementing federated learning across multiple entities.

### BACKGROUND

Financial institutions and related entities are increasingly leveraging data-driven methodologies, using both structured and unstructured data, to enhance their services, spanning from credit risk assessment to detecting financial crime. However, the effectiveness of these methodologies is often limited by the fragmented distribution of important data across various institutions and platforms, and by the sensitivities and regulatory obligations of managing and sharing such private or personal information. Vertical Federated Learning (VFL), an existing approach, enables training of Machine Learning (ML) models across different and siloed institutions without requiring the direct transmission of sensitive data.

Nonetheless, traditional VFL reveals several shortcomings pertaining to data utilization and management. Firstly, it usually disregards valuable publicly available information, such as credit reports and social media insights, thereby limiting the refinement of training models. Secondly, VFL's efficacy is often hampered by the need for abundant overlapping data among participating entities, limiting the predictive capabilities of collaboratively developed models. Moreover, alternative Federated Learning (FL) approaches present additional challenges, such as being confined to single-source knowledge transfer which is inadequate for multi-entity ML systems, or prioritizing non-overlapping samples at the expense of underutilizing publicly accessible data within diverse data spaces.

Consequently, it is desirable to provide a method and system for Federated Learning to address the disadvantages or limitations of the existing art or, at the very least, provide the public with a useful alternative.

### SUMMARY

The present disclosure aims to provide new and useful methods and systems for federated learning, and in particular leveraging various datasets to pre-train ML models in a privacy-preserving manner for implementing federated learning across multiple entities.

In broad terms, the present disclosure proposes a machine learning method configured to implement a first model for processing a first set of data corresponding to a first data space, wherein the first model includes a first feature extractor configured to extract a first set of feature representations. One way of employing this method is implementing a second model to process a second set of data corresponding to a second data space, wherein the second model includes a second feature extractor configured to extract a second set of feature representations. As it can be appreciated from the described embodiment, the method may transfer information from the second model to the first model via a connection, wherein the connection links the first model and the second model. The second model may be trained using a labeled set derived from the second set of data. The first model may be trained using a labeled set derived from the first set of data and a plurality of outputs from the second feature extractor. Parameters of the second model may be aggregated to form a global model.

In particular embodiments, the first model may include a first predictor configured to make predictions based on the extracted first set of feature representations in which the first model is parameterized by parameters corresponding to the first feature extractor and the first predictor. The second model may include a second predictor configured to make predictions based on the extracted second set of feature representations in which the second model is parameterized by parameters corresponding to the second feature extractor and the second predictor.

In implementations, the first model and second model may be linked to form a cascading structure, in which the cascading structure is configured such that outputs of the second model serve as inputs to the first model.

The method may be implemented in a distributed learning framework including a plurality of data management entities, in which each data management entity possesses its own local data and operates its own cascading structure including the first model and the second model, such that each cascading structure is further configured to perform local supervised learning using the local data of the respective data management entity for implementing the cascading structure.

In implementations, the connection linking the first model and the second model may be defined by a plurality of connection parameters and facilitates the linking of a plurality of layers corresponding to the first feature extractor to a plurality of layers corresponding to the second feature extractor, such that the information transferred to the first model includes features or representations learned by the second model.

Each layer of a plurality of layers of the first feature extractor may be configured to receive input from both an output of a preceding layer of the plurality of layers of the first feature extractor and a corresponding layer of a plurality of layers of the second feature extractor, thereby facilitating in the transfer of information from the second model to the first model.

In some embodiments, the training of the second model using the labeled set of the second data may further include minimizing a first optimization function, in which the first optimization function measures a discrepancy between a prediction generated from the second predictor and a ground truth label.

The training of the first model may further include fixing parameters of the second model and minimizing a second optimization function, such that the second optimization function measures a discrepancy between a prediction generated from the first predictor and a ground truth label, and first model parameters are updated to minimize the second optimization function.

In implementations, aggregating of the parameters of the second model to form the global model may further include receiving, at a server, the parameters of the second model from a plurality of parties, computing a weighted average of the received parameters in which a size of a local training batch for the second model is determined, and forming the global model using the computing weighted average of the parameters.

In particular embodiments, a learning module using publicly available data may be employed for implementing a learning process on the global model, such that the learning module employs a consistency regularization technique to regulate a consistency of loss, thereby improving the learning process.

The learning module may include a mask generator, a pretext generator, and a self-supervised learner, in which the self-supervised learner is configured to train the global model using the consistency regularization technique.

In some embodiments, the mask generator may generate a plurality of binary mask vectors for the publicly available data, and the pretext generator uses the binary mask vectors to generate masked samples of the publicly available data.

In implementations, the self-supervised learner may train the global model by minimizing a consistency loss function, where the consistency loss function is defined as a discrepancy between a set of feature representations derived from the publicly available data and a set of feature representations derived from the masked data samples of the publicly available data.

In some embodiments, each of the plurality of binary mask vectors may be generated by sampling from a Bernoulli distribution defined by a probability value with each binary mask vector having a length corresponding to a feature dimension of the second data space.

The consistency loss function may be structured to encourage the global model to maintain a consistent output distribution in response to perturbations in the publicly available data caused by the pretext generator.

In implementations, a loss function may be computed for a fixed data point from the publicly available data based on a stochastic approximation which includes evaluating a batch of the fixed data point and a plurality of generated variants for each fixed data point in the batch.

A Vertical Federated Learning module may be deployed to initialize the module's respective private and public feature extractors such that parameters from the first and second feature extractors of the first and second models respectively are provided as input for the initialization of the private and public feature extractors.

The initialization may facilitate the training of the Vertical Federated Learning module on overlapping samples shared among multiple data management entities, where each entity possesses its own local data and operates within a distributed learning framework.

The Vertical Federated Learning module may include a general predictor configured to receive feature representations outputted from the private and public feature extractors, and to generate a prediction based on the feature representations.

In implementations, the first set of data corresponding to the first data space may include personal or sensitive data and the second set of data corresponding to the second data space may include publicly accessible or publicly available data.

The implementations may be expressed as a method, or alternatively as a system including one or more computers and one or more storage devices storing instructions that when executed by the one or more computers cause the one or more computers to perform the method. It may also be expressed as a computer program product, such as downloadable program instructions (software) or one or more non-transitory computer storage media storing instructions. When executed by one or more computers, the program instructions cause the one or more computers to perform the method.

Embodiments described herein may thereby solve the technical problem of presenting a local pre-training framework and vertical federated learning (VFL) system that accomplishes one or more of the following properties:

Providing a cascade framework for collaborative pre-training on heterogeneous data spaces, which allows each local entity to perform local learning independently and then undertake federated learning collaboratively, thereby enhancing the utility of overlapping samples and improving VFL model initialization, while safeguarding privacy of sensitive data.

Enhancing performance of the VFL model by utilizing unlabelled, publicly available data for self-supervised learning during local pre-training.

Improving collaborative learning amongst various entities or institutions by leveraging external datasets through a self-supervised learning module during the local pre-training.

The above description is provided as an overview of some implementations of the present disclosure. Further description of those implementations, and other implementations, are described in more detail below.

### BRIEF DESCRIPTION OF THE DRAWINGS

Embodiments of the invention will now be explained for the sake of example only, with reference to the following figures in which:

FIG. 1 is a block diagram of an example of a pre-training system according to an embodiment of the invention.

FIG. 2 is a block diagram of an example of a local learning system implemented by the pre-training system of FIG. 1 for training a first machine learning model and a second machine learning model, according to an embodiment of the invention.

FIG. 3 is a block diagram of an example of a refinement learning system implemented by the pre-training system of FIG. 1 for training a global ML model, according to an embodiment of the invention.

FIG. 4 is a flowchart illustrating an example high-level process of using the system of FIG. 1 for federated learning, according to an embodiment of the invention.

FIG. 5 is a block diagram of an example VFL system that leverages parameters from the pre-training system of FIG. 1 for its training process, according to an embodiment of the invention.

FIG. 6 is a block diagram of a node configuration for implementing the pre-training system and the VFL system, according to embodiments of the invention.

FIGS. 7A and 7B illustrate a performance comparison of a VFL model trained using the pre-training system of FIG. 1, against a conventional VFL model, across various datasets, according to an embodiment of the invention.

FIG. 8 is a block diagram illustrating an example computer system which may be configured to implement the systems and methods as disclosed herein.

Like reference symbols in various drawings indicate like elements.

### DETAILED DESCRIPTION

Embodiments will now be discussed with reference to the accompanying FIG.s, which depict one or more exemplary embodiments. These embodiments are described in sufficient detail to enable those skilled in the art to practice the embodiments and it is to be understood that mechanical, logical, and other changes may be made without departing from the scope of the embodiments. Therefore, embodiments may be implemented in many different forms and should not be construed as limited to the embodiments set forth herein, shown in the FIG.s, and/or described below.

Unless otherwise defined, all terms (including technical and scientific terms) used herein are to be interpreted as is customary in the art. It will be further understood that terms in common usage should also be interpreted as is customary in the relevant art.

As used herein, the term “machine learning” may refer to computational techniques for discovering patterns in data and applying the discovered patterns to generate actionable inferences. Instead of relying on specific instructions for every situation, they may use algorithms and statistical models to learn patterns and make predictions.

The term “federated learning,” as used herein, may refer to a method where multiple devices or servers, each with their own data, collaboratively train a shared predictive model while keeping all training data decentralized, enhancing privacy and security.

The term “vertical federated learning,” as used herein, may refer to various entities, each with different sets of data features, collaborating on building a collective machine learning model. The various entities may do this by training individual models on their data and then sharing limited insights (not the data itself) to improve a shared model, ensuring data privacy.

The term “supervised learning,” as used herein, may include a machine learning algorithm using a known set of input-output pairs (labelled data) to learn the relationships between variables, enabling it to make predictions without human intervention.

The term “self-supervised learning,” as used herein, may involve training models on unlabeled data by creating scenarios where the data itself provides supervision. The model may learn by predicting parts of the input data, like guessing missing words in a sentence or completing a partial image.

The term “party,” as used herein with respect to federated learning, may refer to any device or server contributing to the training of a communal model, each possessing unique source data.

The term “server,” as used herein with respect to federated learning, may include an orchestrator, coordinating various parties' training activities and combining their insights to update a shared model.

The term “model,” as used herein with respect to federated learning, may refer to a mathematical framework that is collaboratively trained by multiple parties, designed to perform tasks like prediction or classification based on input data.

The term “local model,” as used herein with respect to federated learning, may refer to an individual machine learning model trained by a party on its own data, separate from the models of other participants.

The term “global model,” as used herein with respect to federated learning, may refer to a consensus model updated iteratively, incorporating insights from local models across all participating parties without directly accessing their data.

The term “data space,” as used herein may include all potential data points that could be used for training a machine learning model. In federated learning, each client may possess a unique portion of this data space, contributing to the diversity of information the global model learns from.

The term “cascade framework” or “cascading architecture,” as used herein may refer to a multi-level system where various modules or layers work sequentially. The output from one module may become the input for the subsequent, creating a flow of information through a hierarchy, often leading to refined results at each stage.

The term “parameter” as used herein may refer to the internal variables that a machine learning model uses to process input data, specifically the weights and biases in a neural network's neurons. These parameters may be integral to the model's ability to learn and make predictions.

The term “knowledge transfer,” as used herein may refer to applying knowledge gained from one area within machine learning to enhance performance in a related area. As used herein, the knowledge transfer may include the insights from a public model to boost the performance of private models, improving efficiency and generalization.

The term “model initialization,” as used herein may refer to the preliminary phase in the model training process, where the initial values for parameters, such as weights and biases in a Vertical Federated Learning (VFL) model, are set. The initialization may be crucial as the initial values of a ML model can influence learning speed, performance, and the model's ability to identify the most optimal outcomes.

The term “overlapping sample,” as used herein with respect to federated learning may refer to data instances that are distributed across various participating entities, with each entity holding a segment of these shared samples.

The term “feature extractor,” as used herein may refer to a component that converts raw data into a format or set of “features” that is more informative and efficient for a model to process. The feature extractor may distill data down to its most essential elements, removing irrelevant noise and highlighting the most critical information for the task.

The term “layer,” as used herein with respect to a feature extractor may refer to a structured set of neurons or units that process input data. Each layer may take in information, apply specific computations or transformations (often non-linear), and pass the output to the next layer, progressively extracting more abstract or complex features from the input.

The term “heterogeneous data space” as used herein with respect to federated learning may refer to diverse and varied datasets across multiple participating entities or nodes. These datasets may different in various aspects including data quality, data distribution, feature space and volume of data.

The term “predictor” as used herein may refer to a machine learning model or algorithm that utilizes learned patterns from data to estimate or infer outputs for unknown or future data points. The predictor may rely on its internal parameters, fine-tuned during a training process, to process input data and produce an output.

The embodiments of the invention pertain to new systems and methods for enhancing federated learning by utilizing public and private datasets to pre-train models across multiple entities, enabling the implementation of federated learning while maintaining data privacy.

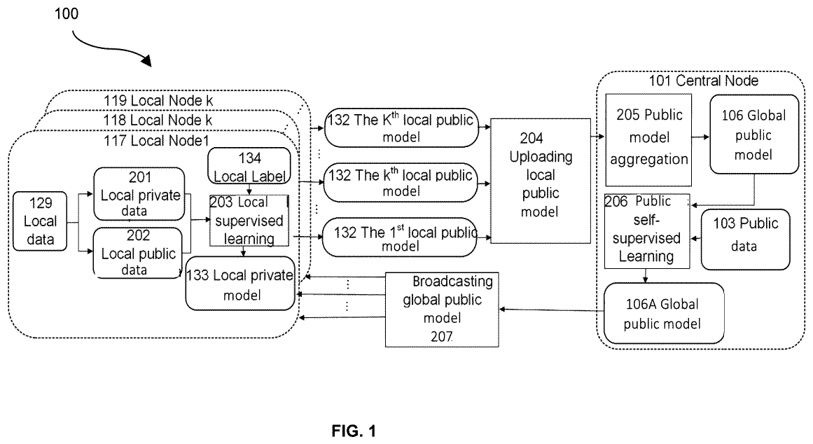

FIG. 1 illustrates is an example pre-training system 100 for federated learning, according to an embodiment of the invention.

In an example embodiment, the system 100 may include multiple local nodes 117-119, each representing individual data management entities, institutions, users, servers, and/or devices engaged in a federated learning process. Each local node (1 to k) may have its own local dataset 129 comprising sensitive local private data 201 and local public data 202. In implementations, the local public data 202 may be external datasets that are publicly available and not sensitive. The local data 129 may be used for training a local private model 133 via local supervised learning 203, ensuring that sensitive information remains within each node, while external public data 202 may serve to enhance the learning process, providing a richer, more diverse input for local supervised learning 203.

In example embodiments, local data 129 may be organized into various data structures for managing and interpreting financial information. For example, local data 129 may be formatted in a time series structure, a hierarchical structure, a network structure, relational structure, and/or a graph structure.

Each local node 117-119 may conduct local supervised learning 203 based on its respective local data 129 and local label 134, resulting in a local private model 133 that remains confidential and a local public model 132 derived from the local supervised learning 203. The local public models (1 to K) 132 can be shared across the pre-training system 100 without compromising data privacy.

In example embodiments, a local private model 133 is trained for federated learning using the pre-training system 100, where raw local user data stays on a local node k and is not accessible to the central server 101.

In embodiments, the local public models 132 may be inputted to an upload module 204 for upload to a central node 101. At the central node 101, a global aggregation module 205 may synthesize the parameters of these models 132, aggregating the parameters of the models 132 into a unified global public model 106. This aggregated model 205 represents the collective insights from all local models (1 to K) but without containing any sensitive private data 201.

In implementations, the central node 101 may further refine the global public model 106 using a public self-supervised learning module 206. This refinement may employ unlabeled data from the external datasets in the public data space 103, allowing the model 106 to learn and improve from the public dataset 103 of the central node 101, without the need for human-labeled input. After the global public model 106 is updated, an updated global public model 106A can be broadcast back to local nodes 1 to k via the broadcasting module 207, providing the local nodes with updated and enhanced features without compromising sensitive data 201.

The above process can repeat with local nodes 117-119 continuing to train their respective private models 133, updating their public models 132, and the central server 101 refining the global model 106 and 106A iteratively. This cyclical nature ensures continuous learning and adaptation to new updates to the data of the pre-training system 100.

The pre-training system 100 provides a robust framework for collaborative machine learning across multiple entities while rigorously maintaining data privacy. It optimally utilizes both local and external datasets for continuous local model improvement, making it particularly advantageous in sectors where data sensitivity is essential, such as healthcare and finance. The framework's use of self-supervised learning with public datasets provides a more sophisticated, adaptable, and privacy-conscious system for pre-training ML models. Moreover, the learned and refined parameters of local public models 132 may be used as initialization for subsequent vertical federated learning (VFL) cycles. This approach allows subsequent VFL to build upon the existing knowledge obtained by the pre-training system 100, thereby reducing the time and computational resources required for future federated learning processes.

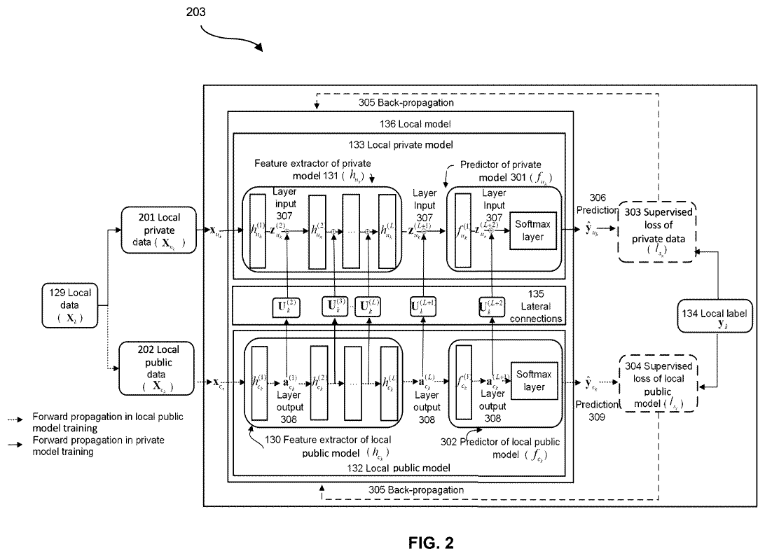

FIG. 2 is a block diagram of an example of a local learning system 203 implemented by the pre-training system of FIG. 1, according to an embodiment of the present disclosure.

As illustrated, local learning system 203 processes local private data 201 and local pubic data 202, which may be non-sensitive. Each type of data may be processed by its corresponding model within each local node 1 to k, the local node or party representing a data management entity, institution, user, server, and/or device. Each local node k may process a respective local public model 132, represented as F_{c}_{ₖ}(⋅; θ_{c}^{k})=h_{c}_{ₖ}(⋅; θ_{c}_{ₕ}^{k})° f_{c}_{ₖ}(⋅; θ_{c}_{_{f}}^{k}), including a respective feature extractor 130 of local public model, represented as h_{c}_{ₖ}, and respective predictor 302, represented as f_{c}_{ₖ}. Correspondingly, each local node k may process a respective local private model 133, represented as Fᵤ_{ₖ}(⋅; θᵤ^{k})=hᵤ_{ₖ}(⋅; θᵤ_{ₕ}^{k})° fᵤ_{ₖ}(⋅; θᵤ_{_{f}}^{k}), including a respective feature extractor of local private model 131, represented as hᵤ_{ₖ}, and respective predictor 301, represented as fᵤ_{ₖ}. In this context, θ_{c}^{k} and θᵤ^{k} represent the parameters for F_{c}_{ₖ} and Fᵤ_{ₖ} respectively. Similarly, θ_{c}_{ₕ}^{k} and θ_{c}_{_{f}}^{k} correspond to the parameters for feature extractor h_{c}_{ₖ} and predictor f_{c}_{ₖ} within the local public model 132. Correspondingly, θᵤ_{ₕ}^{k} and θᵤ_{_{f}}^{k} denote parameters for feature extractor hᵤ_{ₖ} and predictor fᵤ_{ₖ} within the local private model 133. The parameters may refer to weights and/or biases assigned to every neuron in each layer of the neural network, including how the local data 129 is processed and interpreted through every stage or layer of local learning system 203.

In implementations, both feature extractors 130 and 131 (of the public model and the private model) may engage in ‘feature engineering’ which processes the public data X_{c}_{ₖ} and private data Xᵤ_{ₖ} that is inputted in raw format for further analysis and modelling, thereby transforming the data into a format that is informative and useful for the subsequent stages of the local supervised learning 203. Such feature engineering processing may include data cleaning which corrects or removes inaccurate records from a dataset, which includes dealing with missing or inconsistent data. Another feature engineering technique may include data transformation which converts data from one format or structure into another including scaling (adjusting the range of the data) or normalizing (adjusting the data to a standard scale).

Additional feature engineering techniques employed by the feature extractors may include: 1) Feature selection: choosing the most relevant data attributes, i.e. features, for use in modelling, based on their relevance to the target variables or output; 2) Dimensionality Reduction: Simplifying the dataset by reducing the number of input variables or features, yet ensuring the most critical information is retained; 3) Feature Creation: Generating new features or variables from existing ones, often by calculating ratios or creating interaction terms among current variables; 4) Time Series Analysis: Examining data points ordered over time to uncover patterns or trends beneficial for forecasting; 5) Natural Language Processing (NLP): Using algorithms to understand human language, extracting valuable insights from textual data that can inform financial services.

The above listed ‘feature engineering’ techniques offer several advantages, including improved accuracy, reduced dimensionality, and enhanced interpretability of machine learning models. By focusing on relevant features, the predictive accuracy of models is significantly enhanced. Simultaneously, the elimination of superfluous features reduces the model's complexity, potentially boosting its performance. Furthermore, by crafting more intuitive features, the logic and functionality of the model becomes more transparent and understandable, thereby improving interpretability.

In example embodiments, feature extractors hᵤ_{ₖ} and hᵤ_{ₖ} can process the respective data types of local private data 201 and local public data 202 to produce corresponding features or representations, which can be used by the respective predictors f_{c}_{ₖ} and fᵤ_{ₖ} to make predictions about each model.

The components of the public and private models (e.g. public and private feature extractors, predictors, and layer outputs) may be interconnected through lateral connections 135, denoted as {Uₖ^{(l)}(⋅; θ_{U}_{ₖ}^{(l)})}ₗ₌₂^{L+2} where L signifies the total number of layers in their feature extractors.

In implementations, these lateral connections 135 may be one-way connections, which allow the transfer of representations or knowledge learned by the local public model 132 to the private model 133 to enhance the private model's 133 learning process. In implementations, the input of (l+1)^{th} layer of the private model may be calculated as follows zᵤ_{ₖ}^{(l+1)}=zᵤ_{ₖ}^{(l+1)}+Uₖ^{(l+1)}(a_{c}_{ₖ}^{(l)}), 1≤l≤L+1, where the second term is the original input of the (l+1)^{th} layer of the private model part Fᵤ_{ₖ}, and a_{c}_{ₖ}^{(l)} is the output of the l^{th} layer of the public model part Fᵤ_{ₖ}.

In preferred embodiments, the local public model 132 and the local private model 133 may be structured in a cascading architecture, represented as Fₖ, enabling training of the parameters of the local private model 133 without interfering the training of the parameters of the local public model 132.

In some implementations, the cascading architecture of the local learning system 203 allows each data management entity k to first train the local public model, i.e. F_{c}_{ₖ}(⋅; θ_{c}^{k}) using a labelled local public dataset (X_{c}_{ₖ}, Yₖ) by minimizing the following optimization function: [symbol] ₛ_{_{c}}^{k}= [symbol] (F_{c}_{ₖ}(x_{c}_{ₖ}), yₖ), where [symbol] (⋅) is the loss function measuring the difference between the respective prediction and the ground truth label Yₖ. Then, each entity k trains the respective private model and connections {Uₖ^{(l)}(⋅; θ_{U}_{ₖ}^{(l)})}ₗ₌₂^{l=L+2} with labelled local private dataset (Xᵤ_{ₖ}, Yₖ) and layer outputs {a_{c}_{ₖ}^{(l)}}ₗ₌₁^{L+1} of F_{c}_{ₖ} by fixing the respective parameters of the public model F_{c}_{ₖ}(⋅; θ_{c}^{k}) and minimizing the following optimization function: [symbol] ₛ_{ᵤ}^{k}= [symbol] (Fᵤ_{ₖ}(xᵤ_{ₖ}, {Uₖ^{(l+1)}(a_{c}_{ₖ}^{(l)})}ₗ₌₁^{l=L+1}), yₖ), where (xᵤ_{ₖ}, yₖ)∈(Xᵤ_{ₖ}, Yₖ).

In preferred embodiments, the local learning system 203 may implement back-propagation 305, using the calculated losses for each of the private and public models 303 and 304 to update the models' internal parameters (weights and/or biases) to minimize prediction error. This process may be conducted separately within each model for each node k, further enhancing data privacy.

Throughout the above local learning process, the system 203 ensures data privacy by keeping the private and public data separate while allowing the private model to benefit from the public model's insights. This framework not only maintains confidentiality but also enhances the private model's learning efficacy through transferred representations learned by the public model.

### Aggregation of Local Public Models:

In implementations, the local pre-training system 100 for federated learning may include a public model aggregation module 205 which functions to combine the parameters of the local public models 132 from various local nodes or entities into one unified global public model 106.

### Parameter Sharing:

Each entity (or participant local node) in the system 100, indexed by k where 1≤k≤K, may transfer the respective parameters θ_{c}^{k} of their local public model F_{c}_{ₖ}(⋅; θ_{c}^{k}) to the central server/node 101 for further processing. The combined parameters encapsulate the learnings that the local public model has derived from its local data across various entities.

### Aggregation at the Central Server:

In example implementations, the public model aggregation module 205 of the central node 101 may be configured to receive parameters {θ_{c}^{k}}ₖ₌₁^{K} from each local public model {F_{c}_{ₖ}(⋅; θ_{c}^{k})}ₖ₌₁^{K} and aggregates these parameters to construct an aggregated global public model F_{c}(⋅; θ_{c}). The global parameters θ_{c} can be computed as a weighted sum of the local parameters where the weights are the relative sizes of the local training batches. This can be mathematically represented by the formula:

$${θ}_{c} = {\sum }_{k = 1}^{K} \frac{{n}_{c}^{k}}{{\sum }_{i = 1}^{K} {n}_{c}^{i}} {θ}_{c}^{k} ,$$

where n_{c}ⁱ denotes the size of the local training batch for the public model in entity or local node i for 1≤i≤K. This aggregation process allows entities with more substantial and relevant local data to have a proportionally larger influence on the resultant global public model 106.

The resultant global model 106 provides a wider range of data insight than any individual local model 132 could achieve, but also maintains the privacy of the local model data because only local parameter updates, and not the data itself, are shared with the central node 101.

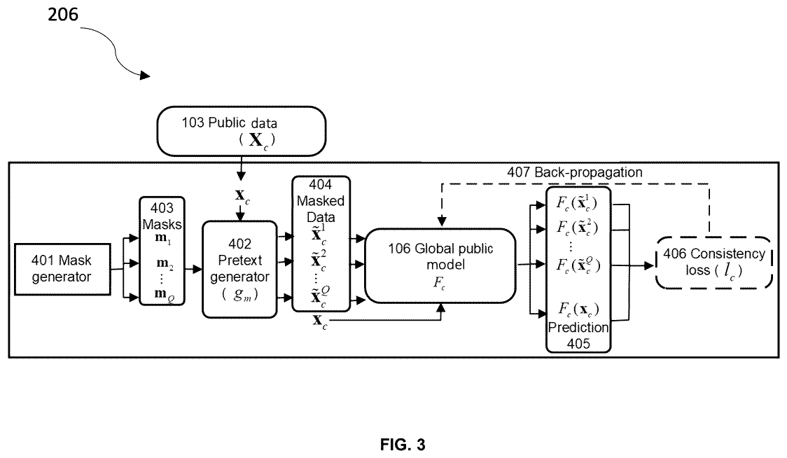

FIG. 3 is a block diagram of an example of a self-supervised learning system 206 implemented by the pre-training system of FIG. 1 for refining the global public model 106, according to an embodiment of the present disclosure.

In some implementations, the self-supervised learning system 206 may be implemented at the central node 101. The learning system 206 focuses on additional training a global public model, denoted as F_{c} utilizing a self-supervised learning approach based on consistency regularization implemented by a predictor/learner which provides a prediction 405 of the global public data, which represents an output of the global public model 106. The learning system 206 operates on publicly accessible data, referred to as x_{c} within a public data space Xc 103. The module's 206 architecture is illustrated in FIG. 3 and may encompass three integral components: a mask generator 401, a pretext generator 402, and the self-supervised learner/predictor.

### Mask Generator Processing

The mask vector generator 401 can be designed to create ‘Q’ unique binary mask vectors. Each of these vectors can be represented as m^{q} and contains a series of elements—specifically, [m₁^{q}, m₂^{q}, . . . , m_{d}_{_{c}}^{q}]—that fall within the binary set of {0,1}^{d}^{_{c}} and are applicable for each q in the range of 1 to Q, represented as (1≤q≤Q). These mask vectors correspond to a specific set of original public data, denoted as x_{c}, which is a subset of X_{c}.

Each individual element, m_{d}^{q}, within a mask vector can be determined by sampling from a Bernoulli distribution, where the probability of selection is defined by pₘ. Here, d_{c} refers to the specific dimension of features present in the public data space. Each mask element selectively hides or alters parts of the input data, forcing the ML model to infer or fill in the gaps.

### Pretext Generator Processing

A distribution process for the masked or “corrupted” data 403, expressed as m\tilde{x}_{c}^{q}, involves a pretext generation operation 402, denoted as gₘ, that takes m^{q} and x_{c} as inputs. The outcome is a combination of the original data and its ‘masked’ version 403, represented mathematically by m^{q}⊙x̅_{c}+(1−m^{q})⊙x_{c}.

The pretext generator 402, denoted as gₘ:χ_{c}×{0,1}^{d}^{_{c}}→χ_{c} takes x_{c} and a mask vector m as input, producing a masked sample. The generating process is expressed as: \tilde{x}_{c}^{q}=gₘ(m^{q}, x_{c})=m^{q}⊙x̅_{c}+(1−m^{q})⊙x_{c}, where the d-th feature x̅_{c}(d) of x̅_{c} is sampled from the empirical marginal distribution of the d-th feature in the public dataset X_{c}, i.e,

$${\overline{x}}_{c} ( d ) ∼ {p}_{{x}_{c} ( d )} = \frac{1}{{N}_{p}} {\sum }_{i = 1}^{{N}_{p}} δ ( {( {x}_{c} )}_{i} ( d ) ) .$$

Here, (x_{c})ᵢ(d) is the d-th feature of the i-th sample in the public dataset X_{c}.

The pretext generator processing ensures that the altered sample retains characteristics that are not just structured in a table format (i.e. tabular data), but also bear a close resemblance to other entries in the public dataset X_{c}. The efficacy of consistency learning is associated with this ensured resemblance between training samples, a scenario commonly encountered with specialized data sets that ML models are often trained on. This approach to data masking is pivotal in ensuring that the ML models are trained on data that, while altered, still reflect the characteristics of the original dataset, thereby making the learning process more robust and relevant.

### Estimating Loss

As depicted in FIG. 3, a prediction 405 of the global public data representing an output of the global public model 106 can be used to optimize the efficacy of global public model F_{c}(⋅; θ_{c}) by reducing a consistency loss 406. This loss 406 may be calculated based on the discrepancies between the refined global model's predictions based on the original dataset x_{c} and those from its corresponding masked form, \tilde{x}_{c}.

The mathematical representation of this consistency loss, [symbol] _{c}, may be formulated as an expectation:

$${E}_{{x}_{c} ∼ {p}_{{x}_{c} ,} m ∼ {p}_{m} , {\tilde{x}}_{c} ∼ {g}_{m} ( {x}_{c} , m )} [ {( {F}_{c} ( {x}_{c} ) - {F}_{c} ( {\tilde{x}}_{c} ) )}^{2} ]$$

which corresponds to squared difference between the outputs of F_{c}(x_{c}) and its masked variant F_{c}(\tilde{x}_{c}). This form of loss measurement is significant for completing the public model to sustain stable prediction patterns, even when there are minor modifications or disturbances in the input data x_{c}.

Furthermore, an average or stochastic estimate of loss of the self-supervised learning, denoted as [symbol] _{c}, can be computed by

$$\frac{1}{{n}_{c} Q} {\sum }_{i = 1}^{{n}_{c}} {\sum }_{q = 1}^{Q} {( {F}_{c} ( {x}_{c} ) - {F}_{c} ( {\tilde{x}}_{c} ) )}^{2} ,$$

which corresponds to taking the mean of the squared differences between F_{c}'s predictions for x_{c} and \tilde{x}_{c} over all samples and mask vectors, where n_{c} is a batch size. The probability distribution of each m_{d} within the mask can be described using a Bernoulli distribution, with the likelihood of each feature's presence in the mask being determined by pₘ, which may be represented as m˜Πⱼ₌₁^{d}^{_{c}} Bern (m_{d}|pₘ).

When considering a fixed public dataset x_{c}, the inner expectation of the above loss can be taken with respect to pₘ and gₘ(x_{c}, m) which may be represented as the variance of the predictions of corrupted and masked samples.

Once the consistency loss 406 is computed, a back-propagation 407 may be performed using the values of the calculated consistency loss 406 to make information adjustments to the global public model's F_{c}(⋅; θ_{c}) existing parameters.

This refinement and self-supervised learning system 206 encourage the global public model to provide consistent outputs for an input sample, even when the data sample is slightly altered or “corrupted” (as by the pretext generator). This refinement learning process improves the global model's robustness and its ability to generalize because it has to learn the underlying, invariant features of the data that remain true across these perturbations.

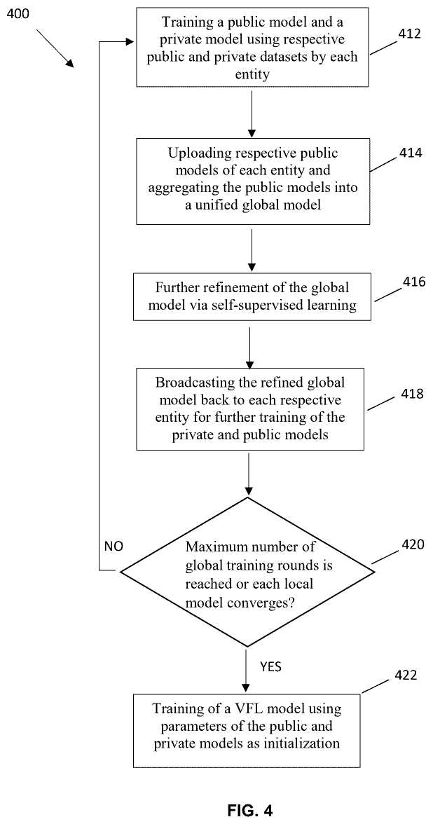

FIG. 4 is a flowchart illustrating an example high-level process 400 of using the system of FIG. 1 for federated learning, according to an embodiment of the present disclosure.

In step 412, a public model 132 and a private model 133 is trained locally using respective public 202 and private 201 datasets by each local entity k. For example, the entity may correspond to an individual organization, device, or local server. The public model 132 of each entity may process local public data 202 corresponding to a publicly shared data set. The private model 133 of each entity may process local private data 201 corresponding to a private data set which isn't shared outside of the respective local entity due to privacy concerns. Additionally, each entity can input features or representations learned from their public model 132 into their corresponding private model 133, facilitating the transfer of learned knowledge from the public model 132 to the private model 133.

In step 414, each entity shares via an uploading module 204 their trained public model 132 to a central server 101. The server then aggregates these models into a single global model 106, which effectively combines the insights gained from each of the trained public models 132.

In step 416, the aggregated global model 106 is further refined via a self-supervised learning process. This refinement process may include masking, where central server 101 may create corresponding variations of the public data 103 as masked or “corrupted” data 404 to ensure the global model 106 can handle these variations. Consistency learning is further performed on the updated global model 106 to ensure that the model's predictions are consistent for a given data sample, even when small changes (perturbations) are made to that data sample.

In step 418, the refined global model is broadcasted back to each respective entity for further training of the local private and public models of each entity for further local supervised learning such as the learning process 203 described with respect to FIG. 2.

In step 420, the process 400 arrives at a decision point, which acts as a stop condition, to determine whether the maximum number of global training rounds has been reached or if each local (private and public) model has converged. This step 420 ensures that the iterative process of training and refining the global and local models doesn't continue indefinitely. If either of the specified conditions are met, the process proceeds to use the trained models for Vertical Federated Learning (VFL) in step 422. If neither of the conditions are met, the process 400 returns to step 412, where the training of the local public and private models resumes.

In step 422, the initialization of Vertical Federated Learning (VFL) utilizes the updated parameters of the pre-trained public models 132 and private models 133 from step 408. The VFL model undergoes further training, specifically on the overlapped data samples shared among multiple entities, enhancing its performance and accuracy.

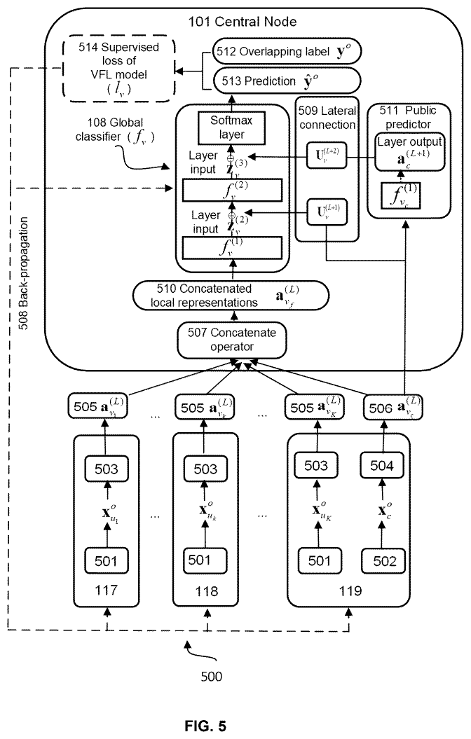

FIG. 5 is a block diagram of an example VFL system 500 that leverages parameters from the local pre-training system of FIG. 1 for its training process, according to an embodiment of the present disclosure.

### Initialization of the VFL System

As depicted in FIG. 5, for each party ‘k’, local private feature extractors as represented as {hᵥ_{ₖ}(⋅; θᵥ_{ₕ}^{k})}ₖ₌₁^{K} and a public model module Fᵥ_{_{c}}(⋅; θᵥ_{_{c}}) are initialized using parameters of the pre-trained local models corresponding to the pre-training framework 100 of FIG. 1.

In embodiments, for each party ‘k’ within the range of 1 to K, the initial parameter values for their local private feature extractor modules θᵥ_{ₕ}^{k(0)} are initially set to the values of θᵥ_{ₕ}^{k} from their respective pre-trained local models, as provided in the following equation: θᵥ_{ₕ}^{k(0)}=θᵤ_{ₕ}^{k}, 1≤k≤K.

Similarly, in implementations, for the public model part Fᵥ_{_{c}}(⋅; θᵥ_{_{c}}) of the system 500, party K may use parameter values θ_{c} from the global public model F_{c}(⋅; θ_{c}) as its initial values. This may be indicated in the following equation: θᵥ_{_{c}}⁽⁰⁾=θ_{c}, where θᵥ_{_{c}}⁽⁰⁾ is set to equal θᵥ_{_{c}}. In particular, θᵥ_{ₕ}^{c(0)}=θ_{c}_{ₕ} and θᵥ_{_{f}}^{c(0)}=θ_{c}_{_{f}}, where θ_{c}_{ₕ} and θ_{c}_{_{f}} are the parameters of the feature extractor h_{c} and the predictor f_{c} of the global public model F_{c}(⋅; θ_{c}), respectively.

### Training of the VFL System

In some embodiments, after initialization, the VFL model parameters corresponding to Fᵥ(⋅; θᵥ) may be trained through a process of loss function minimization. The objective of the loss function minimization can be to adjust the VFL model parameters so that the model's predictions ŷᵥ^{o} are as close as possible to the actual labels y^{o} minimizing the discrepancy between these two, which is quantified by the following loss function L: [symbol] ᵥ= [symbol] (ŷ^{o}, y^{o}).

### Data Representation of the VFL System

In example implementations of the VFL system 500, [xᵤ_{₁}^{o}, . . . , xᵤ_{ₖ}^{o}, . . . , xᵤ_{_{K}}^{o}, xᵤ_{_{K}}^{o}, x_{c}^{o}]=xₒ∈Xₒ, where xᵤ_{ₖ}^{o} (1≤k≤K) is the part of overlapping sample xₒ in a private data space for each party k, and x_{c}^{o} is the part of an overlapping sample xₒ in the public data space for each party k. In example implementations, overlapping samples xₒ may relate to data segments distributed across various entities, where each entity holds a specific subset of an entire dataset. In this context, such overlapping samples correspond to shared data fragments, representing the contributions from each entity to the complete dataset.

In various embodiments, local nodes 117-119 may contain overlapping private data 501 which corresponds to sensitive user information from a private data space and/or overlapping public data 502 which corresponds to non-sensitive and/or publicly available information from a public data space. Each local node may include one or more types of feature extractors 503 or 504. The VFL private feature extractor 503 may process the private data without exposing it, while the public feature extractor 504 may process the public data. These feature extractors 503 and 504 can transform raw private or public data into a format that the machine learning model 500 can use, known as features or representations. The output from each feature extractor may be a set of high-level representations 505 or 506. Outputted local private representations 505 correspond to private data 501 and outputted local public representations 506 correspond to public data 502. The local private representations 505 and public representations 506 from all nodes may be further combined using a concatenation operator 507. Here, the operator 507 is configured to not see the private data 501 itself but receives the features/representations 505 extracted from the data 501. It merges these features into a single representation.

In various embodiments, the operator 507 may merge these representations 505 into a single set of concatenated local representations 510. The concatenated local representations 510 can be fed into a global classifier 108. This classifier 108, which may comprise of multiple input layers and a softmax layer, makes a prediction 513. The softmax layer may be a type of output layer that turns the raw output of the input layers into probabilities for each possible class in a classification task. In parallel to the primary processing sequence of the VFL 500 by the central node 101, a public predictor 511 may be configured to provide additional information to the global classifier 108 through a set of lateral connections 509. This supplementary public data or a pre-trained model from the public predictor 511 may enhance the classification task of the system 500. The VFL model's performance may be assessed by calculating a supervised loss 514. This metric compares the model's predictions 513 against actual outcomes (known as overlapping labels 512), which can be often shared or overlapping across nodes. The loss function 514 evaluates how well the model 500 is performing, wherein a lower loss indicates better performance.

The VFL model 500 allows multiple data management entities to collaboratively train a machine learning model using their combined data, without exposing sensitive information to each other. It achieves this by keeping private data local, extracting features locally, and then only sharing these features or representations, not the original data, with the other parties for model training. This methodology is crucial for maintaining data privacy and compliance with data protection regulations.

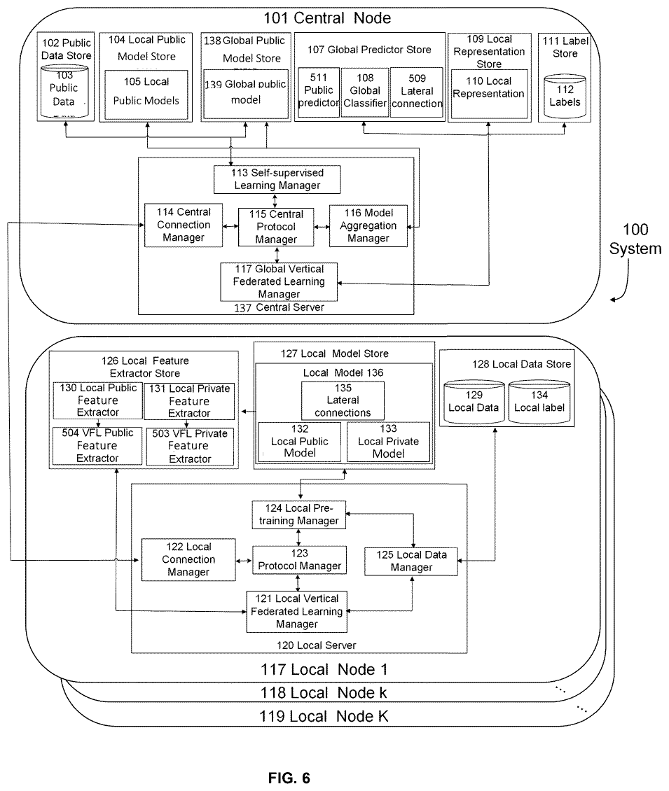

FIG. 6 is a block diagram of an example environment for implementing the local pre-training system and the VFL system, according to embodiments of the present disclosure.

In the example of FIG. 6, a central node 101 is provided. The central node 101 can include a central server 137 implemented using hardware or software. The central server 137 can aggregate and train a global public model 139, provide the global public model 139 to local nodes 117-119, receive and manage the storage and tracking of local public models 105, and generate or collect relevant metadata. Additionally, the central server 137 can train a global predictor 511, provide backward gradient to local nodes 117-119, receive and manage the storage and tracking of local representations 110, and generate or collect relevant metadata.

According to an example, the central node 101 can include a global public model store 138. The global public model store 138 can store the global public model 139. This can include storing the metadata relevant to the global public model 139. This metadata can include a version of the global public model 139 and a training data corresponding to the global public model 139. The global public store can comprise a database or memory, or can include one or several discrete memory devices.

In an example, the central node 101 can include a local public model store 104. The local public model store 104 can store the local public models 105. These models, which may be binary representations of the layers, nodes, and weights, can be stored within the local public model store 104. Additionally, the local public model store 104 can contain metadata that pertains to the local public model 105, including information on the model's source, methods of validating its trustworthiness, and details related to its training. The local public model store 104 can be implemented using a database or memory, which may include of one or more discrete memory devices, or an allocated portion of memory.

According to an example, the central node 101 may feature a public data store 102 that stores the public records of customers involved in financial tasks. These records may be accessed through APIs or obtained from data providers in certain embodiments. The public records within the store can also contribute to self-supervised learning on a global public model 139.

The public data store 102 can take the form of a database or memory, which may be a portion of a larger memory allocation or composed of one or more distinct memory devices.

In an example, the central node 101 can include a global predictor store 107. The global predictor store 107 can include binary of the global predictor, which binary can identify layers, nodes, and weighting values of the global predictor.

According to an example, the central node 101 may incorporate a local representation store 109 that is capable of storing the local representation 110 received from the local nodes 117-119. The store may hold the binary of the local representations 110, which accurately represents the dimensions and values of the local representations 110. Additionally, metadata relevant to the local representations 110 can also be stored in the local representation store 109. This metadata may include identification of the source of the local representations 110 and the corresponding sample IDs.

In an example, the local representation store 109 can be implemented as a database or memory, which could include an allocated portion of memory or one or several discrete memory devices.

According to an example, the central node 101 can contain a label store 111 that holds the labels 112 of the data stored in the node of the party responsible for the central node 101. These labels 112 can be represented in binary format to reflect their respective values. Additionally, the label store 111 may contain metadata related to these labels 112, such as corresponding sample IDs. The label store 111 can take the form of a database or memory, which can either be an allocated portion of a single memory device or several discrete memory devices.

According to an example, the central server 137 may be equipped with a suite of managers, including the protocol manager 115, central connection manager 114, model aggregation manager 116, self-supervised learning manager 113, and local vertical federated learning manager. These managers may be configured to be easily accessible and modifiable by the central server 137, providing maximum control over the system. The model aggregation manager 116 may work in conjunction with both the global public model store 138 and local public model store, while the self-supervised learning manager 113 may be compatible with the global public model store 138 and public data store 102. Furthermore, the global vertical federated learning manager 117 may be paired with the label store 111, local representation store 109, and global predictor store 107. The central protocol manager 115 may serve as the hub of the system, connecting with the model aggregation manager 116, self-supervised learning manager 113, global vertical federated learning manager 117, and central connection manager 114 to facilitate seamless communication between all components.

In the context of the present system, the function of the model aggregation manager 116 may be configured to create a unified global public model 139 by aggregating the local public models 105 stored in the local public model store 104. Once generated, the global public model 139 can be provided to the global public model store 138 for storage. This ensures that the global public models 139 are readily accessible and available for future use. Additionally, the aggregation manager may be equipped to retrieve and provide information on model performance, including metadata associated with models stored in the global model store. The aggregation manager can be implemented as hardware or software and can form an integral component of the central server 137.

In an example, the self-supervised learning manager 113 can be capable of training a global public model 139 using unlabelled public data 103. This manager can be designed to communicate with both the public data store 102 and the global model store. As a result, it can access and grant access to any data stored within the public data store 102. By utilizing the public data store 102, the self-supervised learning manager 113 may be configured to conduct self-supervised learning on the global public model 139. Once the model has been learned, the model can be stored in the global public model store 138. These models can then be shared with local nodes 117-119 and stored in their respective local model stores 127.

In an example, a role of the global vertical federated learning manager 117 is to enhance the performance of a predictor, which it can achieve through communicational coupling with the label store 111, local representation store 109, and global predictor store 107. By accessing the local representation store 109, the manager can create a comprehensive combination of the local representations 110. Additionally, the global vertical federated learning manager 117 can utilize the label store 111 to train the global predictor, using the combined local representations 110 as input and the labels 112 from the label store 111 as the ground truth. The global predictor can then be stored in the global predictor store 107, allowing for future access and further optimization.

According to an example, the protocol manager 115 at the central node 101 may serve as a communication hub for local nodes 117-119. In some implementations, its primary function can be to facilitate message exchange between the central node 101 and local nodes 117-119, including learning protocols. This exchange may enable a range of interactions, such as queries, updates to public models, and sharing gradients for vertical federated learning models. Additionally, the protocol manager 115 can play a key role in establishing federated learning configurations, transmitting local representations 110 of vertical federated learning models, and managing ciphertext for entity alignment.

According to an example, the central connection manager 114 serves as the primary interface for establishing and managing connections between the central node 101 and the local nodes 117-119. Its primary function is to facilitate networking operations for our invention. More specifically, the central connection manager 114 is responsible for establishing and managing the communication and network channels between the central node 101 and local nodes 117-119.

According to an example, each of the local node can include a local data store 128. The local data store 128 can store customer information associated with the local node. Part of this customer information can be private and cannot be accessible by the central node 101 or any other nodes, while the rest part of this customer information can be accessed through APIs or purchased from providers. The customer information in the local data store 128 can be used in supervised training the local model 136 stored in the local model store 127 and in supervised training the vertical federated learning model of which the feature extractors stored in the local feature extractor store 126 and the predictor 511 stored in the central node 101. The local data store 128 can comprise a database or memory. This memory can include an allocated portion of a memory, or can include one or several discrete memory devices.

In an example, each of the local nodes 117-119 can include a local model store 127, which serves as a repository for the locally trained model. This local model 136 may comprise of both a private model and a public model. The public model may be updated with the global public model 139 received by the local node, which is also stored in the local model store 127. The local model store 127 can take the form of a database or memory, with the memory being either a dedicated portion of memory or a collection of discrete memory devices.

In an example, each of the local nodes 117-119 can include a local feature extractor store 126. This store may include both a public feature extractor 130 and a private feature extractor 131, which are initialized by the feature extractors of the local public model 132 and the local private model 133, respectively. The local model store 127 can include either a database or memory, including an allocated portion of memory or one or multiple discrete memory devices.

According to an example, the local protocol manager 123 can play a crucial role in facilitating communication among local nodes 117-119 on local server 120, as well as between local nodes 117-119 and the central node 101, much like its central counterpart. Additionally, the local protocol manager 123 can exercise governance over the exchange of messages within and between these nodes. Such messages may comprise of numerous types, ranging from queries and updates of public models, to gradients of vertical federated learning models and the establishment of federated learning configurations. The local protocol manager 123 can also handle local representations 110 of the vertical federated learning model and ciphertext for entity alignment.

In the context of the present system, the local pre-training manager 124 responsible for local pre-training may be capable of training the cascade model framework within the local node. The local pre-training manager 124 can establish communication with the local data store 128 through the local data manager 125. This enables the local data manager 125 to access and provide access to the data stored locally on local server 120. In certain scenarios, the local data 129 within the data store can be isolated for a specific local node. By accessing the local data 129 in the data store, the local pre-training manager 124 can effectively train the cascade model. Once trained, the cascading models can then be stored in the local model store 127.

In certain embodiments, the role of the local vertical federated learning manager 121 may be to modify the numerous learnable parameters of the local feature extractors in response to the received backward gradient from the central node 101. Additionally, this manager may produce local representations 110 by utilizing the outputs of the local feature extractors and the local vertical federated learning manager 121 may be connected to both the local feature extractor store 126 and the local data store 128. The local data manager 125, on the other hand, allows for access to overlapped samples that have been aligned by the protocol manager 123.

In some implementations, the role of the local connection manager 122 may act as a connection interface that links the central node 101 with the local nodes 117-119. The invention's networking operations may be facilitated by the local connection manager's 122 ability to establish and manage these connections. More specifically, the local connection manager 122 can be responsible for managing the communication and network between the central and local nodes 117-119.

### Experimental Results

The following section describes various experiments conducted to evaluate embodiments of the disclosure. Some of these experiments illustrate embodiments of the disclosure other than those discussed above.

Experiments were carried out to evaluate the machine learning invention, particularly focusing on the performance of the newly developed models during the pre-training phase (termed Ours-Local) and the Vertical Federated Learning phase (termed Ours-VFL), by comparing the newly developed models with established baseline models across various data scenarios.

This evaluation was conducted utilizing five distinct datasets, each tailored for classification tasks, to provide a broad-spectrum analysis of the models' performance.

It should be emphasized that the experiments and outcomes presented herein serve as exemplary illustrations and were conducted under particular conditions employing one or more specific embodiments. Consequently, neither the described experiments nor their findings should be construed as restricting the breadth of the disclosure encompassed by the present patent document.

Baselines The performance of the invention is assessed by comparing the local models trained during the pre-training phase (termed Ours-Local) and the Vertical Federated Learning model (termed Ours-VFL) with several state-of-the-art baseline methodologies:
1. FedAvg utilizes common feature data to train models. Following the FedAvg protocol, a global classifier is trained for each party. The performance of Ours-Local is then compared to that of FedAvg.
2. Local Training (Local): In this setup, each party independently trains its local model utilizing its own dataset. The performance of Ours-Local is compared to this Local training scheme.
3. Vertical Federated Learning with Partial Input (VFL (Partial Input)): Initially, a VFL model is trained using overlapping samples. During the inference phase, each party uses its locally stored sample feature representation as input, while setting the feature representations from other parties to zero vectors. The performance of Ours-Local is compared to VFL (Partial Input).
4. Vertical Federated Learning (VFL): VFL, a standard split learning framework, is trained using all overlapping samples. A comparison is made between the performance of Ours-VFL and VFL.
5. Vertical Federated Learning with Pre-trained Public Model (VFL-P): VFL-P extends the standard VFL by initially training a public model using public features via FedAvg. Subsequently, the parties collaboratively train a model from scratch, while keeping the parameters of the pre-trained public model fixed. The performance of Ours-VFL is compared to VFL-P.

### Datasets

The experiments are executed on five distinct datasets: Vehicle Default Loan, accessed from Tianchi Alibaba Cloud (URL: https://tianchi.aliyun.com/dataset/111029), Financial Default Loan, accessed from Tianchi Alibaba Cloud (URL: https://tianchi.aliyun.com/dataset/140861), and three datasets from AutoML—Helena, Covtype, and Jannis, accessed from ChaLearn AutoML (URL: https://automl.chalearn.org/data). All these datasets are utilized for classification tasks. The fundamental details of these datasets are presented in Table 1.

TABLE 1
Fundamental Dataset Information

| Dataset | Sample Number | Feature Number | Class Number |
|---|---|---|---|
| Financial Default Loan | 45000 | 40 | 2 |
| Vehicle Default Loan | 20000 | 48 | 2 |
| Covtype | 20000 | 54 | 7 |
| Helena | 20000 | 27 | 100 |
| Jannis | 20000 | 54 | 4 |

### Sample Splitting:

All datasets are segregated into training, validation, and test sets following a 6:2:2 ratio. Unless specified otherwise, 25% of the training set is maintained as overlapping samples distributed across each party, with the remaining samples evenly allotted to each party.

TABLE 2
Feature Splitting Setting for Vehicle Default Loan and
Financial Default Loan

| Party ID/Dataset | Vehicle Default Loan | Financial Default Loan |
|---|---|---|
| 1 | MAI | AI |
| 2 | SAI | BI |
| 3 | AI | — |
| Public Features | CI | CI |

### Feature Splitting:

The feature splitting for Vehicle Default Loan and Financial Default Loan is detailed in Table 2. Since credit information is accessible to all authorized entities, the CI feature set in both loans is designated as the public feature set. For the Vehicle Default Loan, CI is taken as the public feature set, with the other three feature sets distributed among three parties. Conversely, for Financial Default Loan, AI and BI are recognized as two private feature sets distributed across two parties.

For Helena, Jannis, and Covtype, in the absence of feature descriptions, features are randomly segregated into public common features and others. The proportion of public common features is set as ⅓ unless explicitly stated otherwise. The residual features are evenly divided among the number of parties, each segment serving as the private features for the corresponding party. The experiments are executed three times, altering the feature splitting method randomly each time, and compute the average performance to ascertain the impact of different feature distribution strategies

### Evaluation Metrics:

Table 3 illustrates two distinct evaluation metrics employed to analyze classification performance, contingent on the number of classes within the datasets. These metrics are derived from a confusion matrix. For binary classification tasks as seen in Financial Default Loan and Vehicle Default Loan datasets, the Area Under the ROC Curve (AUC) is utilized to gauge the performance of the method alongside the baselines. Conversely, for datasets with multiple classification tasks such as Helena, Covtype, and Jannis, accuracy as the evaluative metric is employed.

Additionally, the number of training epochs required to attain the specified model performance is measured. This serves as a metric to evaluate the training efficiency of both the invention and the baseline methodologies.

TABLE 3
Evaluation Metrics for Each Dataset

| | Vehicle | Financial | | | |
|---|---|---|---|---|---|
| | Default | Default | | | |
| Metric | Loan | Loan | Helena | Covtype | Jannis |
| AUC | √ | √ | | | |
| Accuracy | | | √ | √ | √ |
| Number of | √ | √ | √ | √ | √ |
| epochs | | | | | |

In this manner, a comprehensive assessment of performance and training efficiency across different datasets and classification tasks is achieved.

### Results

The outcomes of the experiments demonstrate that the models trained using method of the invention—Ours-Local and Ours-VFL—significantly outperform the baseline approaches. Firstly, both Ours-Local and Ours-VFL attain superior classification performance compared to the baselines. Secondly, Ours-VFL exhibits enhanced training efficiency during the VFL training phase, achieving comparable accuracy with notably fewer training epochs.

As depicted in Table 4, Ours-Local surpasses the three baseline approaches for the financial default loan dataset. Similarly, Table 5 shows that Ours-Local excels over the three baselines across all datasets.

Table 6 presents a comparative analysis of test accuracy scores between Ours-VFL, VFL-p, VFL, and Local on the Jannis, Covtype, and Helena datasets. Here, Ours-VFL markedly outperforms VFL and significantly surpasses Local across all datasets. For instance, Ours-VFL exhibits a 5.4% accuracy improvement over VFL on the Jannis dataset, and enhances accuracy by 4.1% and 9% on Helena and Covtype, respectively. Moreover, when compared to VFL with a pre-trained public model, Ours-VFL shows a performance boost of 1.9%, 2.9%, and 4.6% on Jannis, Helena, and Covtype datasets, respectively. These results indicate that Ours-VFL effectively leverages a pre-trained local model for initialization, significantly enhancing the federated model performance.

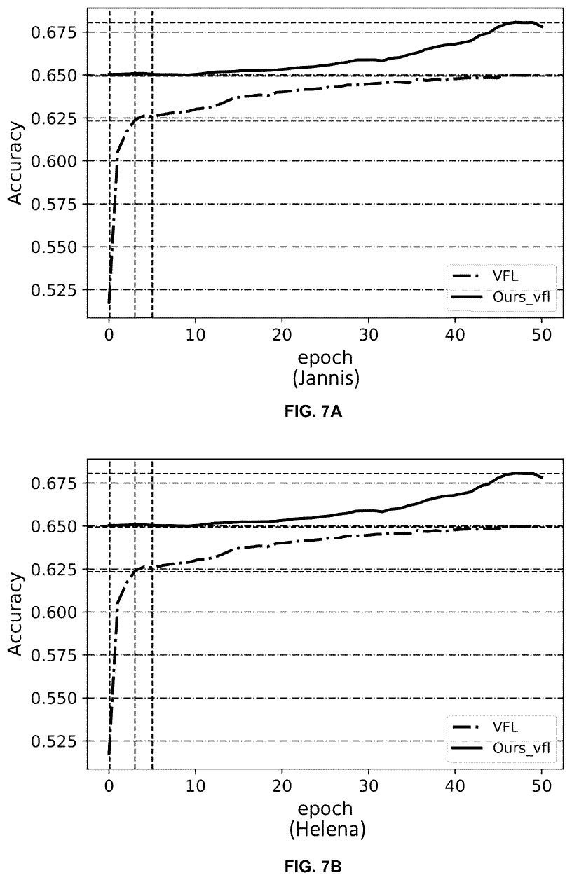

FIG. 7, which includes FIGS. 7A and 7B, illustrates the enhanced performance achieved by Ours-VFL when equipped with a pre-trained local model across two different datasets. Specifically, FIG. 7A depicts the performance gain observed in the Jannis dataset, and FIG. 7B depicts the performance gain observed in the Helena dataset. In both FIGS. 7A and 7B, Ours-VFL exhibits superior performance not only towards the endpoint but also during the very early epochs, indicating a higher initial performance level in all scenarios. All values depicted in FIG. 7, calculated on the validation set from the first epoch through epoch 50, highlight the advantage of leveraging the pre-trained local model. By doing so, models can achieve comparable accuracy levels with substantially fewer training epochs within federated experiment settings. of epochs on the Helena dataset. In both FIGS. 7A and 7B, Ours-VFL exhibits superior performance not only towards the endpoint but also during the very early epochs, indicating a higher initial performance level in all scenarios. All values depicted in FIG. 7, calculated on the validation set from the first epoch through epoch 50, highlight the advantage of leveraging the pre-trained local model. By doing so, models can achieve comparable accuracy levels with substantially fewer training epochs within federated experiment settings.

TABLE 4
Test AUC Score Comparison of Ours-Local to Local, FedAvg, and VFL(Partial Input)
on Financial Default Loan and Vehicle Default Loan (↑ denotes the performance gain of Ours-
Local compared to Local)

| Dataset | Party ID | Our-local(Semi) | Local | FedAvg | VFL (Partial Input) |
|---|---|---|---|---|---|
| Financial Default Loan | 1(AI) | 0.6481(↑15.7%) | 0.6107 | 0.5863 | 0.6273 |
| | 2(BI) | 0.6246(↑19.3%) | 0.5714 | 0.5863 | 0.5371 |
| Vehicle Default Loan | 1(MAI) | 0.6875 | 0.6839 | 0.6874 | 0.6455 |
| | 2(SAI) | 0.6846 | 0.6854 | 0.6875 | 0.6771 |
| | 3(AI) | 0.6902 | 0.6899 | 0.6866 | 0.6802 |

TABLE 5
Average Test Accuracy Score Comparison of Ours-Local to Local, FedAvg, and
VFL(Partial Input) on Covtype, Jannis, and Helena (↑ denotes the performance gain of Ours-
Local compared to Local)

| Dataset | Ours-local | Local | FedAvg | VFL (partial input) |
|---|---|---|---|---|
| Covtype | 0.718(↑10.22%) | 0.6514 | 0.6147 | 0.5845 |
| Jannis | 0.6835(↑6.5%) | 0.6414 | 0.6347 | 0.5672 |
| Helena | 0.285(↑7.7%) | 0.2842 | 0.2644 | 0.0975 |

TABLE 6
Performance Comparison of Ours-VFL to Local, VFL, and VFL-P (↑ denotes the
performance gain compared to VFL).

| Dataset | Ours-vf(Semi) | Ours-vf(Sup) | VFL-P | VFL | Local |
|---|---|---|---|---|---|
| Financial Default Loan | 0.7451(↑10.6%) | 0.7391 | 0.7091 | 0.6736 | — |
| Vehicle Default Loan | 0.6988(↑5.3%) | 0.6908 | 0.6978 | 0.6622 | — |
| Jannis | 0.6912(↑7.7%) | 0.6805 | 0.6627 | 0.6494 | 0.6414 |
| Helena | 0.294(↑3.4%) | 0.2878 | 0.3144 | 0.3053 | 0.2842 |
| Covtype | 0.7458(↑12.9%) | 0.7359 | 0.7062 | 0.6748 | 0.6514 |

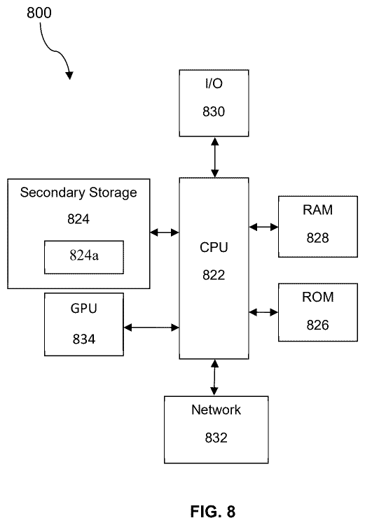

FIG. 8 is a block diagram of a computing device 800 configured to implement functionalities of both the central node 101 and the local nodes 117-119, in accordance with the embodiments of the systems and methods disclosed herein. The computing device 800 includes a processor 822 (which may be referred to as a central processor unit or CPU) that is in communication with memory devices including secondary storage 824 (such as disk drives), read only memory (ROM) 826, random access memory (RAM) 828. The processor 822 may be implemented as one or more CPU chips. The computing device 800 may further comprise input/output (I/O) devices 830, and network connectivity devices 832. The secondary storage 824 is typically comprised of one or more disk drives or tape drives and is used for non-volatile storage of data and as an over-flow data storage device if RAM 828 is not large enough to hold all working data. Secondary storage 824 may be used to store programs which are loaded into RAM 828 when such programs are selected for execution.

In this embodiment, the secondary storage 824 has an order processing component 824a comprising non-transitory instructions operative by the processor 822 to perform various operations of the method of the present disclosure. The ROM 826 is used to store instructions and perhaps data which are read during program execution. The secondary storage 824, the RAM 828, and/or the ROM 826 may be referred to in some contexts as computer readable storage media and/or non-transitory computer readable media.

I/O devices 830 may include printers, video monitors, liquid crystal displays (LCDs), plasma displays, touch screen displays, keyboards, keypads, switches, dials, mice, track balls, voice recognizers, card readers, paper tape readers, or other well-known input devices.

The processor 822 executes instructions, codes, computer programs, scripts which it accesses from hard disk, floppy disk, optical disk (these various disk-based systems may all be considered secondary storage 824), flash drive, ROM 826, RAM 828, or the network connectivity devices 832. While only one processor 822 is shown, multiple processors may be present. Thus, while instructions may be discussed as executed by a processor, the instructions may be executed simultaneously, serially, or otherwise executed by one or multiple processors.

In the computing device 800, a graphics processing unit (GPU) 834 can be included to enhance processing capabilities. The GPU 834 is a specialized electronic circuit designed for rendering images, animations, and video, and is highly efficient at parallel processing tasks. This makes them well-suited for various machine learning and artificial intelligence related operations. The GPU 834 communicates with the processor 822, secondary storage 824, ROM 826, RAM 828, I/O devices 830, and network connectivity devices 832. It can be integrated within the processor 822 as an integrated GPU (iGPU) or as a separate, dedicated GPU connected through a high-speed interface. Inclusion of the GPU 834 allows for more efficient processing of tasks that benefit from parallelism, leading to increased system performance, especially in applications optimized for GPU-based processing. The GPU 834 can also offload tasks from the CPU 822, improving overall system efficiency. By incorporating the GPU 834 into the computing device, the system can be transformed into a specific purpose machine with enhanced processing capabilities for parallel tasks, as taught by the present disclosure.

Although the computing device 800 is described with reference to a single computer, it should be appreciated that the computing device may be formed by two or more computers in communication with each other that collaborate to perform a task. For example, but not by way of limitation, an application executing the federated learning process 400, as illustrated in FIG. 4, may be partitioned in such a way as to permit concurrent and/or parallel processing of the instructions of the application, contributing to efficient learning and computation across the federated learning process 400. Alternatively, the data processed by the application may be partitioned in such a way as to permit concurrent and/or parallel processing of different portions of a data set by the two or more computers. In an embodiment, virtualization software may be employed by the computing device 800 to provide the functionality of a number of servers that is not directly bound to the number of computers in the computing device 800. In an embodiment, the functionality disclosed above may be provided by executing parts or entirety of the application and/or applications in a cloud computing environment. Cloud computing may comprise providing computing services via a network connection using dynamically scalable computing resources. A cloud computing environment may be an on-premises private cloud environment or a commercially available public cloud environment.

Additional components, such as one or more application specific integrated circuits, neuromorphic computing units, field programmable gate arrays, or other electronic or photonic processing components can also be included and used in conjunction with or in place of the processor 822 to perform processing operations. The processing operations can include machine learning operations, other operations supporting the machine learning operations, or a combination thereof.

The technical solution detailed in present disclosure may be embodied in the form of a computer program product. The computer program product may be stored in a non-volatile or non-transitory storage medium, which can be a compact disk read-only memory, USB flash disk, or a removable hard disk. The computer program product includes a number of instructions that enable a computer device (personal computer, server, or network device) to execute the methods provided in the embodiments described herein. For example, such an execution may correspond to a simulation of the logical operations, including the training and aggregation of model updates in the federated learning process, as described herein. The software product may additionally or alternatively include number of instructions that enable the computing device 800 to execute operations for configuring or programming a digital logic apparatus in accordance with embodiments of the present invention.

By programming and/or loading executable instructions onto the computing device, at least one of the CPU 822, the RAM 828, and the ROM 826 are changed, transforming the computing device in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

It will be appreciated to those skilled in the art that the preceding examples and embodiments are exemplary and not limiting to the scope of the present disclosure. Whilst the foregoing description has described exemplary embodiments, it will be understood by those skilled in the art that many variations of the embodiment can be made within the scope and spirit of the present invention. It shall be noted that elements of any claims may be arranged differently including have multiple dependencies, configurations and combinations.

1. A machine learning method comprising:
implementing a first model to process a first set of data corresponding to a first data space, wherein the first model comprises a first feature extractor configured to extract a first set of feature representations;
implementing a second model to process a second set of data corresponding to a second data space, wherein the second model comprises a second feature extractor configured to extract a second set of feature representations;
transferring information from the second model to the first model via a connection, wherein the connection links the first model and the second model;
training the second model using a labeled set derived from the second set of data; training the first model using a labeled set derived from the first set of data and a plurality of outputs from the second feature extractor; and
aggregating parameters of the second model to form a global model.

2. The method of claim 1, wherein the first model further comprises a first predictor configured to make predictions based on the extracted first set of feature representations, the first model being parameterized by parameters corresponding to the first feature extractor and the first predictor; and wherein the second model further comprises a second predictor configured to make predictions based on the extracted second set of feature representations, the second model being parameterized by parameters corresponding to the second feature extractor and the second predictor.

3. The method of claim 1, wherein the first model and second model are linked to form a cascading structure, the cascading structure being configured such that outputs of the second model serve as inputs to the first model.

4. The method of claim 1, wherein the method is implemented in a distributed learning framework comprising a plurality of data management entities, wherein each data management entity possesses its own local data and operates its own cascading structure comprising the first model and the second model, wherein each cascading structure is further configured to perform local supervised learning using the local data of the respective data management entity for implementing the cascading structure.

5. The method of claim 1, wherein the connection linking the first model and the second model is defined by a plurality of connection parameters and facilitates the linking of a plurality of layers corresponding to the first feature extractor to a plurality of layers corresponding to the second feature extractor, wherein the information transferred to the first model comprises features or representations learned by the second model.

6. The method of claim 1, wherein each layer of a plurality of layers of the first feature extractor is configured to receive input from both an output of a preceding layer of the plurality of layers of the first feature extractor and a corresponding layer of a plurality of layers of the second feature extractor, thereby facilitating in the transfer of information from the second model to the first model.

7. The method of claim 2, wherein the training of the second model using the labeled set of the second data further comprises minimizing a first optimization function, the first optimization function measuring a discrepancy between a prediction generated from the second predictor and a ground truth label.

8. The method of claim 7, wherein the training of the first model further comprises fixing parameters of the second model and minimizing a second optimization function, the second optimization function measuring a discrepancy between a prediction generated from the first predictor and a ground truth label, and first model parameters are updated to minimize the second optimization function.

9. The method of claim 1, wherein the aggregating of the parameters of the second model to form the global model further comprises: receiving, at a server, the parameters of the second model from a plurality of parties, computing a weighted average of the received parameters wherein a size of a local training batch for the second model is determined, and forming the global model using the computing weighted average of the parameters.

10. The method of claim 1, wherein a learning module using publicly available data is employed for implementing a learning process on the global model, said learning module employing a consistency regularization technique to regulate a consistency of loss, thereby improving the learning process.

11. The method of claim 10, wherein the learning module comprises a mask generator, a pretext generator, and a self-supervised learner, wherein the self-supervised learner is configured to train the global model using the consistency regularization technique.

12. The method of claim 11, wherein the mask generator generates a plurality of binary mask vectors for the publicly available data, and the pretext generator uses the binary mask vectors to generate masked samples of the publicly available data.

13. The method of claim 11, wherein the self-supervised learner trains the global model by minimizing a consistency loss function, the consistency loss function defined as a discrepancy between a set of feature representations derived from the publicly available data and a set of feature representations derived from the masked data samples of the publicly available data.

14. The method of claim 12, wherein each binary mask vector from the plurality of binary mask vectors is generated by sampling from a Bernoulli distribution defined by a probability value with each binary mask vector having a length corresponding to a feature dimension of the second data space.

15. The method of claim 13, wherein the consistency loss function is structured to encourage the global model to maintain a consistent output distribution in response to perturbations in the publicly available data caused by the pretext generator.

16. The method of claim 11, wherein for a fixed data point from the publicly available data, a loss function is computed based on a stochastic approximation which comprises evaluating a batch of the fixed data point and a plurality of generated variants for each fixed data point in the batch.

17. The method of claim 1, wherein a Vertical Federated Learning module is deployed to initialize its respective private and public feature extractors and parameters from the first and second feature extractors of the first and second models respectively are provided as input for the initialization of the private and public feature extractors.

18. The method of claim 17, wherein the initialization facilitates the training of the Vertical Federated Learning module on overlapping samples shared among multiple data management entities, each entity possessing its own local data and operating within a distributed learning framework.

19. The method of claim 17, wherein the Vertical Federated Learning module comprises a general predictor configured to receive feature representations outputted from the private and public feature extractors, and to generate a prediction based on said feature representations.

20. The method of claim 1, wherein the first set of data corresponding to the first data space comprises personal or sensitive data and the second set of data corresponding to the second data space comprises publicly accessible or publicly available data.

21. A machine learning system, comprising:
a first module configured to implement a first model to process a first set of data corresponding to a first data space, wherein the first model comprises a first feature extractor configured to extract a first set of feature representations;
a second module configured to implement a second model to process a second set of data corresponding to a second data space, wherein the second model comprises a second feature extractor configured to extract a second set of feature representations;
a communication interface configured to facilitate the transfer of information from the second model to the first model via a connection, wherein the connection links the first and second model;
a training unit configured to train the second model using a labeled set derived from the second set of data and train the first model using a labeled set derived from the first set of data and a plurality of outputs from the second feature extractor; and
an aggregation unit configured to aggregate parameters of the second model to form a global model.

22. A non-transitory computer-readable medium having instructions stored thereon, which when executed by a computer, cause the computer to perform operations comprising:
implementing a first model via a first module to process a first set of data corresponding to a first data space, wherein the first model comprises a first feature extractor configured to extract a first set of feature representations;
implementing a second model via a second module to process a second set of data corresponding to a second data space, wherein the second model comprises a second feature extractor configured to extract a second set of feature representations;
transferring information from the second model to the first model via a connection through a communication interface, wherein the connection links the first model and the second model;
training the second model using a training unit with a labeled set derived from the second set of data;
training the first model using the training unit with a labeled set derived from the first set of data and a plurality of outputs from the second feature extractor; and
aggregating parameters of the second model via an aggregation unit to form a global model.
